(19) United States
(12) Patent Application Publication
(10) Pub. No.: US 2022/0245080 A1
(43) Pub. Date: Aug. 4, 2022

(54) METHOD FOR COMMUNICATION OF A COMPONENTIZED APPLICATION, COMPUTING DEVICE AND COMPUTER STORAGE MEDIUM

(71) Applicant: BOE TECHNOLOGY GROUP CO., LTD., Beijing (CN)

(72) Inventors: Zhe ZHANG, Beijing (CN); Yingjie LI, Beijing (CN); Pengyu LIU, Beijing (CN)

(21) Appl. No.: 17/486,534

(22) Filed: Sep. 27, 2021

(30) Foreign Application Priority Data
Jan. 29, 2021 (CN) 202110129519.X

(51) Int. Cl. G06F 13/40; G06F 13/20; G06F 9/54

(52) U.S. Cl. CPC G06F 13/4022; G06F 9/546; G06F 13/20; G06F 13/405

(57) ABSTRACT

A method for communication of a componentized application is described, including acquiring, by the source routing bus component, a routing message to be sent, in response to a message type of the routing message being an out-of-app message to be sent to a first target component included in a target application, establishing, by the source routing bus component, an external binding routing by binding a remote service, the external binding routing being a message transmission path between the source routing bus component and a target message dispatch service component in the target application to which the routing message is to be sent, and sending, by the source routing bus component, the routing message to the target message dispatch service component through the external binding routing, so that the first target component in the target application obtains the routing message.

### RELATED APPLICATION

The present application claims the benefit of Chinese Patent Application No. 202110129519.X filed on Jan. 29, 2021, the entire disclosure of which is incorporated herein by reference.

### FIELD

The present disclosure relates to the field of componentization technologies, especially to a method for communication of a componentized application, a computing device and a computer storage medium.

### BACKGROUND

As the business of applications used in an operating system (for example, applications in the Android system) becomes more and more complicated, applications involve more and more application projects. Therefore, if a slight modification is made to each application project, the entire application needs to be recompiled. This highly coupled development mode leads to low application development efficiency.

Componentization development is to split the business functions of an application. Each business function is an individual application project, and each application project can run independently as an independent component. Components in the multiple independent components are then combined according to business requirements to construct one or more applications.

However, current applications developed based on componentization are confronted with many urgent problems to be solved.

### SUMMARY

In view of the above-mentioned deficiencies or shortcoming in the prior art, it is desirable to provide a method and apparatus for communication of a componentized application, a computing device, and a computer storage medium, so as to solve the communication problem of an application developed based on componentization.

According to an aspect of the present disclosure, there is provided a method for communication of a componentized application, the componentized application at least comprising a source routing bus to component, and the method comprising:

acquiring, by the source routing bus component, a routing message to be sent;

in response to a message type of the routing message being an out-of-app message to be sent to a first target component included in a target application, establishing, by the source routing bus component, an external binding routing by binding a remote service, the external binding routing being a message transmission path between the source routing bus component and a target message dispatch service component in the target application to which the routing message is to be sent;

sending, by the source routing bus component, the routing message to the target message dispatch service component through the external binding routing, so that the first target component in the target application obtains the routing message.

According to an aspect of the present disclosure, there is provided a method for communication of a componentized application, the componentized application comprising a first target component, a target routing bus component, and a target message dispatch service component, and the method comprising:

receiving, by the target message dispatch service component, a remote service binding request sent by a source routing bus component included in a source application;

in response to receiving the remote service binding request, establishing an external binding routing between the target message dispatch service component and the source routing bus component, the external binding routing being a message transmission path between the source routing bus component and the target message dispatch service component in the componentized application, wherein the source routing bus component sends a routing message to the target message dispatch service component through the external binding routing;

in response to the routing message sent through the external binding routing being received, sending, by the target message dispatch service component, the routing message to the target routing bus component through an internal binding routing, the internal binding routing being a message transmission path between the target message dispatch service component and the target routing bus component;

sending, by the target routing bus component, the routing message to the first target component in the componentized application.

According to an aspect of the present disclosure, there is provided an apparatus for communication of a componentized application, the apparatus comprising a source routing bus component, wherein,

the source routing bus component is configured to acquire a routing message to be sent; and in response to a message type of the routing message being an out-of-app message to be sent to a first target component included in a target application, establish an external binding routing by binding a remote service, the external binding routing being a message transmission path between the source routing bus component and a target message dispatch service component in the target application to which the routing message is to be sent;

the source routing bus component is further configured to send the routing message to the target message dispatch service component through the external binding routing, so that the first target component in the target application obtains the routing message.

According to an aspect of the present disclosure, there is provided an apparatus for communication of a componentized application, the application comprising a first target component, a target routing bus component, and a target message dispatch service component, and the apparatus comprising:

a target message dispatch service component being configured to receive a remote service binding request sent by a source routing bus component included in a source application; in response to receiving the remote service binding request, establish an external binding routing between the target message dispatch service component and the source routing bus component, the external binding routing being a message transmission path between the source routing bus component and the target message dispatch service component in the componentized application to which the routing message is to be sent;

the target message dispatch service component being further configured to, when the routing message sent through the external binding routing is received, send the routing message to the target routing bus component through an internal binding routing, the internal binding routing being a message transmission path between the target message dispatch service component and the target routing bus component;

the target routing bus component being further configured to send the routing message to the first target component in the componentized application.

According to an aspect of the present disclosure, there is provided a computing device, comprising a processor and a memory having computer instructions stored thereon that perform any method described in the embodiment of the present disclosure when the computer instructions are executed by the processor

According to an aspect of the present disclosure, there is provided a computer-readable storage medium having computer instructions stored thereon that perform any method described in the embodiment of the present disclosure when the computer instructions are executed

### BRIEF DESCRIPTION OF THE DRAWINGS

By reading the detailed description of non-limiting embodiments with reference to the following drawings, other features, purposes and advantages of the present disclosure will become more apparent.

FIG. 1 illustrates a schematic view of an application scenario of a method for communication of a componentized application provided by an embodiment of the present disclosure;

FIG. 2 illustrates schematic structural views of multiple applications developed based on componentization provided by an embodiment of the present disclosure;

FIG. 3 illustrates a flow chart of a method for communication of a componentized application provided by an embodiment of the present disclosure;

FIG. 4 illustrates a flow chart of another method for communication of a componentized application provided by an embodiment of the present disclosure;

FIG. 5 illustrates a flow chart of a further method for communication of a componentized application provided by an embodiment of the present disclosure;

FIG. 6 illustrates a flow chart of yet another method for communication of a componentized application provided by an embodiment of the present disclosure;

FIG. 7 illustrates a schematic view of an interactive communication between applications provided by an embodiment of the present disclosure;

FIG. 8 illustrates a schematic view of an interaction for out-of-app messages provided by an embodiment of the present disclosure;

FIG. 9 illustrates a schematic view of an interactive communication within an application provided by an embodiment of the present disclosure;

FIG. 10 illustrates a schematic view of an interaction for intra-app messages provided by an embodiment of the present disclosure;

FIG. 11 illustrates a schematic structural view of an apparatus for communication of a componentized application provided by an embodiment of the present disclosure;

FIG. 12 illustrates a schematic structural view of another apparatus for communication of a componentized application provided by an embodiment of the present disclosure;

FIG. 13 illustrates a schematic structural view of a computer system provided by an embodiment of the present disclosure.

### DETAILED DESCRIPTION

The present disclosure will be further described in detail below with reference to the accompanying drawings and embodiments. It can be understood that the specific embodiments described here are only used to explain the content of the present disclosure, but not to limit the present disclosure. In addition, it is to be noted that, to facilitate description, only the portions related to the present disclosure are shown in the drawings.

It is to be noted that the embodiments in the present disclosure and the features in the embodiments can be combined with each other in the case of causing no conflict. Hereinafter, the present disclosure will be described in detail with reference to the drawings and in conjunction with the embodiments.

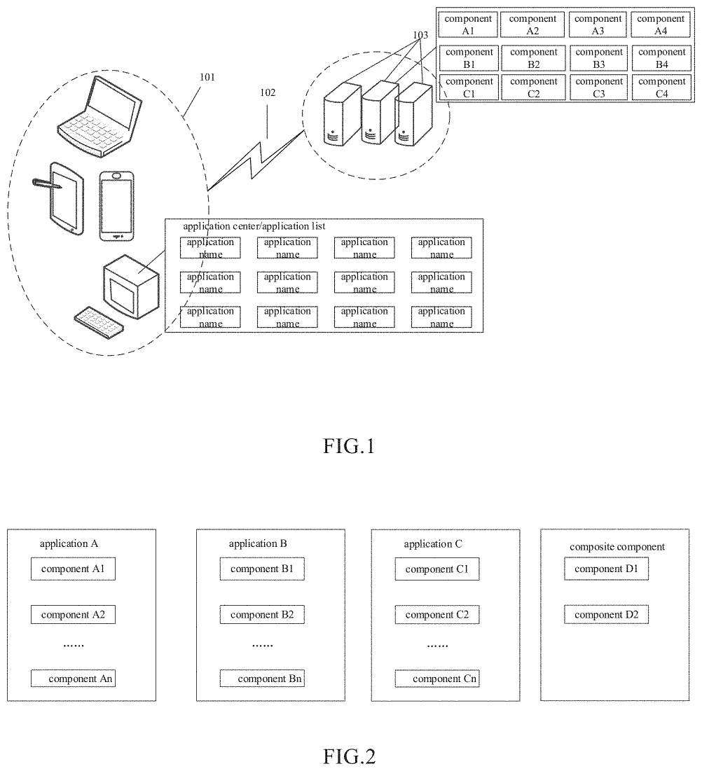

Referring to FIG. 1, it illustrates a schematic view of a scene of a method for communication of a componentized application provided by an embodiment of the present disclosure. As shown in FIG. 1, the user can write a source code of a component by a terminal device 101, and then store the written source code of the component into a server 103 via a network 102. With the development of applications, especially the componentization and modularization of mobile applications, different users can merge the repeated component source codes into one component, and call components stored in the underlying layer to form functional modules with different functions. Further, an application can be constructed by calling between different functional modules.

Componentization refers to the process of splitting and recombining multiple functional modules when decoupling a complicated system. Its purpose is to split the complicated system into multiple components, separate component boundaries and responsibilities, and facilitate independent upgrading and maintenance. A modular development method may be used. A single component includes four parts: a template, a data structure, a program, and a style. The interface of a component expresses to the function provided by the component and the parameters required when it is called. Components can be developed and tested individually. Moreover, multiple persons are allowed to collaborate at the same time to write, develop, and research different functional modules.

For example, on an application platform constructed by componentized applications, developers write component source codes by a terminal device 101, or access and query the component source codes that have been written, or customize mobile applications.

For example, a component management platform pre-installed on the terminal device 101 is used to realize querying and editing operations on components, or realize functions such as editing, accessing and calling multiple applications developed based on componentization.

As shown in FIG. 1, the server 103 can store multiple component source codes or component packages, application information and details thereof, and provide business data for applications.

The terminal device 101 includes, but is not limited to, a desktop computer, a notebook computer, a mobile computing device with computing processing capabilities, and the like.

The network 2 may include a wireless network or a wired network, and standard communication technologies and/or protocols are used through the wireless network or the wired network. The network is usually the Internet, but may also be any network, including but not limited to a local area network (LAN), a metropolitan area network (MAN), a wide area network (WAN), a mobile, wired or wireless network, a private network, or virtual private networks, or any combination thereof.

The server 103 includes, but is not limited to, an independent physical server, a server cluster or a distributed system composed of multiple physical servers, and a cloud server providing basic cloud computing services such as cloud services, cloud databases, cloud computing, cloud functions, cloud storage, network services, cloud communication, middleware services, domain name services, security services, CDN, big data and artificial intelligence platforms.

As shown in FIG. 2, FIG. 2 illustrates schematic structural views of multiple applications developed based on componentization provided by an embodiment of the present disclosure. This is implemented, for example, in the application scenario shown in FIG. 1, where multiple applications written and developed based on the terminal device 101 may be used as an application matrix, and construction parameters may be transmitted to an application in the application matrix in the manner of network connection. The application may be a software pre-installed on a smart terminal, that is, an independent software, or may also be a composite component that implements some functions in the software. The composite component refers to a collection of components used to implement partial program functions, such as the commonly seen “scan and scan” function, “shake and shake” function, and so on.

Assuming that an application A includes one or more components, such as a component A1, a component A2, a component An, etc., and an application B includes one or more components, such as a component B1, a component B2, a component Bn, etc., and a composite component may include one or more components, such as a component D1, a component D2. In order to realize the normal operation of an application, data communication needs to be performed between multiple components within the application so as to realize the functions of the application. Data communication may also need to be performed between two applications (for example, application A and application B), for example, a certain component of the application A may need to communicate with a certain component within the application B. In addition, due to the diversification of application development, multiple components included in an application may be restricted by memory occupancy conditions, so that some of the components need to be reused. As a result, multiple applications may all require out-of-app (i.e., non-intra-app) communication with a composite component for realizing a certain to function. How to realize communication between components in applications developed based on a componentized framework is an important problem to be solved urgently.

In the embodiments of the present disclosure, intra-app communication refers to communication between multiple components included in the same application developed based on componentization. For example, the communication between the component A1 and the component A2 within the application A in FIG. 2 may be referred to as an intra-app communication. Out-of-app communication refers to communication between different applications developed based on componentization. For example, the communication between the component A1 of the application A and the component B1 of the application B in FIG. 2 may be referred to as an out-of-app communication.

In order to solve the above problem, the present disclosure proposes an application communication method, which can effectively solve the problem of free communication between applications developed by a componentized framework.

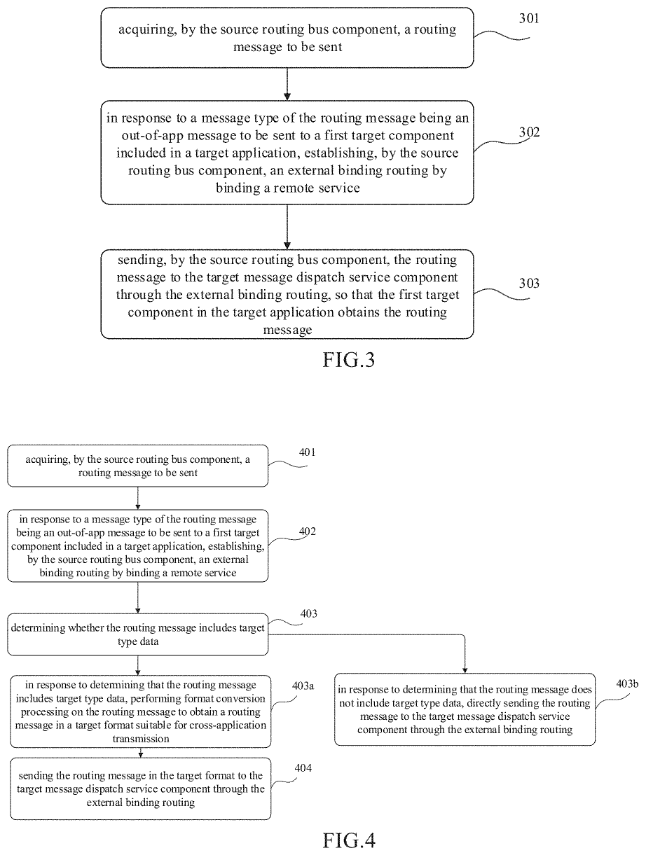

Referring to FIG. 3, it illustrates a flow chart of a method for communication of a componentized application proposed by an embodiment of the present disclosure. As shown in FIG. 3, the method may be executed by an application communication apparatus, which may be a component included in a source application based on a certain operating system (for example, Android operating system). The component includes, but is not limited to, an independently installed application or a composite component that implements a certain function in an application, and the component includes but is not limited to an activity or a service. The componentized application is a source application, and the source application at least includes a source routing bus component. As an example, the method may be executed by the source routing bus component, which is of course not limiting. Specifically, the method comprises steps 301-303.

Step 301: Acquiring, by the source routing bus component, a routing message to be sent.

Step 302: In response to a message type of the routing message being an out-of-app message to be sent to a first target component included in a target application, establishing, by the source routing bus component, an external binding routing by binding a remote service, the external binding routing being a message transmission path between the source routing bus component and a target message dispatch service component in the target application to which the routing message is to be sent. The remote service described here is, for example, a service provided by a component in the target application (for example, a target dispatch service component or a first target component).

Step 303: Sending, by the source routing bus component, the routing message to the target message dispatch service component through the external binding routing, so that the first target component in the target application obtains the routing message.

In the above steps, the componentized application (also referred to as the source application in this embodiment) refers to a sending terminal of the routing message. The source routing bus component refers to a component in the source application which is used to implement routing message delivery and publishing. The target application refers to a receiving terminal of the routing message.

The routing message refers to a message sent to realize the function of a certain component (for example, a message initiating component). This function includes but is not limited to calling a page, calling a service, acquiring data, transmitting a message, etc. The content of the transmitted message includes but is not limited to file content, etc.

In order to realize the communication between the source application and the target application, the embodiment of the present disclosure proposes that the source routing bus component in the source application sends a request to the target message dispatch service component of the target application for establishing a routing path, such as establishing an external binding routing by binding a remote service. The external binding routing refers to a message transmission path between the source routing bus component and the target message dispatch service component in the target application to which the routing message is to be sent. When the source routing bus component obtains the routing message, the source routing bus component determines whether an external binding routing needs to be established, for example, according to the message type of the routing message. When the source routing bus component determines that the routing message is an out-of-app message according to the message type of the routing message, the external binding routing is established by binding a remote service.

After the external binding routing is established, the message sent by a component (for example, a message initiating component) of the source application is processed by the source routing bus component and then dispatched to the external binding routing. Since the external binding routing has been established between the target message dispatch service component of the target application and the source routing bus component, the target message dispatch service component of the target application realizes a message relay between the source routing bus component and the target routing bus component.

On the basis of the above embodiment, when the source routing bus component determines that the message type of the routing message is an out-of-app message, the source routing bus component establishes an external binding routing by binding a remote service, and meanwhile further sends a request to the target message dispatch service component of the target application for registering a callback interface. The source routing bus component binds the target message dispatch service component through a remote service, and sends a request for registering a callback interface to the target message dispatch service component, thereby establishing a two-way channel between the source routing bus to component and the target message dispatch service component. When the target application returns a response message for the routing message, the response message is directly transmitted back to the source routing bus component through the callback interface, and the response message is fed back to the component sending the routing message via the source routing bus component.

The embodiment of the present disclosure realizes communication between different applications by establishing an external binding routing between the source routing bus component and the target message dispatch service component when there is a requirement for communication between different applications, which can effectively improve the efficiency of communication between different applications.

In the embodiment of the present disclosure, an intra-app message indicates that the routing message is to be sent to other components included in the source application, and an out-of-app message indicates that the routing message is to be sent to a target component included in the target application.

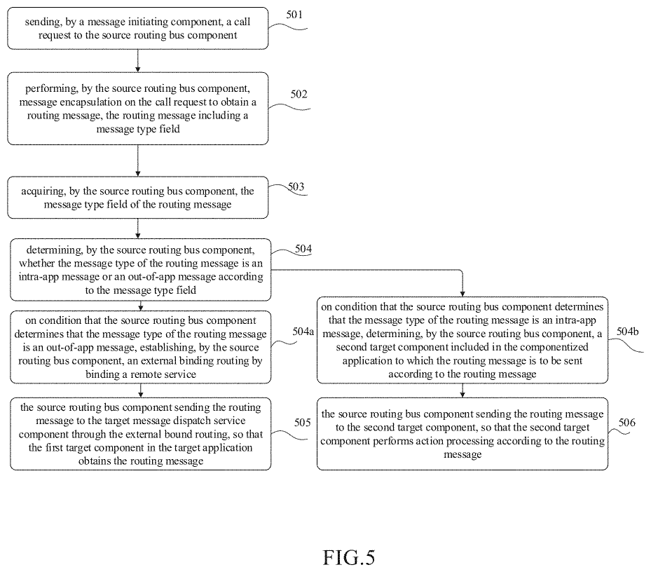

On the basis of the above embodiment, FIG. 4 illustrates a flow chart of another method for communication of a componentized application provided by an embodiment of the present disclosure. The method may be executed by an application communication apparatus, which may be a component included in a source application based on a certain operating system (for example, Android operating system). The component includes, but is not limited to, an independently installed application or a composite component that implements a certain function in an application, and the component includes but is not limited to an activity or a service. The componentized application is a source application, and the source application at least includes a source routing bus component. As an example, the method may be executed by the source routing bus component, which is of course not limiting. The method comprises the following steps.

Step 401: Acquiring, by the source routing bus component, a routing message to be sent.

Step 402: In response to a message type of the routing message being an out-of-app message to be sent to a first target component included in a target application, establishing, by the source routing bus component, an external binding routing by binding a remote service. The external binding routing is a message transmission path between the source routing bus component and the target message dispatch service component in the target application to which the routing message is to be sent. As described with reference to FIG. 3, at that time, the source routing bus component may send a request to the target message dispatch service component of the target application for registering a callback interface.

Step 403: Determining whether the routing message includes target type data. As an example, in the environment of the Android operating system, the source routing bus component may call a message processor to determine whether the routing message includes target type data.

Step 403a: In response to determining that the routing message includes target type data, performing format conversion processing on the routing message to obtain a routing message in a target format suitable for cross-application transmission. Then, in step 404, the routing message in the target format is sent to the target message dispatch service component through the external binding routing.

Step 403b: In response to determining that the routing message does not include target type data, directly sending the routing message to the target message dispatch service component through the external binding routing.

In this embodiment, when the source routing bus component sends the routing message to the target message dispatch service component through the external binding routing, it can be determined whether the routing message includes target type data. If the routing message includes target type data, the routing message is subjected to format conversion processing so as to obtain a routing message in a target format suitable for cross-application transmission to be transmitted. If the routing message does not include target type data, the routing message is directly sent to the target message dispatch service component through the external binding routing.

In the above embodiment, the target type data refers to data whose data type meets a preset condition, for example, multimedia data whose data type is picture, audio, audio and video, short video, etc., that is, large data blocks. As an example, in the environment of the Android operating system, the source routing bus component can call DataWrapper (i.e. message processor) through the ApkCommunicationManager class to perform format conversion processing on the routing message, and transmit the routing message that has experienced the conversion processing in a Binder transmission mode. For example, in the case that the routing message contains target type data in a JSON string format, the target type data can be converted into a routing message in a target format suitable for cross-application transmission according to a data conversion format. The target format includes but is not limited to the format of a binary byte stream. Subjecting the target type data to format conversion processing proposed by the embodiment of the present disclosure can effectively solve the problems existing in the transmission of large data blocks, and effectively improve the transmission speed of out-of-app messages.

In some embodiments, when the source routing bus component determines that the message type of the routing message is an intra-app message, a second target component in the source application to which the routing message corresponds can be determined according to the routing message. The routing message is sent to the second target component, so that the second target component performs action processing according to the routing message.

In the embodiment of the present disclosure, the source routing bus to component distinguishes an intra-app message from an out-of-app message to improve the transmission accuracy of routing messages.

On the basis of the above embodiment, as shown in FIG. 5, FIG. 5 illustrates a flow chart of a further method for communication of a componentized application provided by an embodiment of the present disclosure. The method may be executed by an application communication apparatus, which may be a component included in a source application based on a certain operating system (for example, Android operating system). The component includes, but is not limited to, an independently installed application or a composite component that implements a certain function in an application, and the component includes, but is not limited to, an activity or a service. The componentized application is a source application, and the source application at least includes a source routing bus component. As an example, the method may be executed by the source routing bus component, which is of course not limiting. The method comprises the following steps.

Step 501: Sending, by a message initiating component, a call request to the source routing bus component.

Step 502: Performing, by the source routing bus component, message encapsulation on the call request to obtain a routing message, the routing message including a message type field. The routing message includes a message type field indicating whether the routing message is an intra-app message or an out-of-app message.

Step 503: Acquiring, by the source routing bus component, the message type field of the routing message.

Step 504: Determining, by the source routing bus component, whether the message type of the routing message is an intra-app message or an out-of-app message according to the message type field.

Step 504a: On condition that the source routing bus component determines that the message type of the routing message is an out-of-app message, establishing, by the source routing bus component, an external to binding routing by binding a remote service. Then, in step 505, the source routing bus component sends the routing message to the target message dispatch service component through the external bound routing, so that the first target component in the target application obtains the routing message.

Step 504b: On condition that the source routing bus component determines that the message type of the routing message is an intra-app message, determining, by the source routing bus component, a second target component included in the componentized application to which the routing message is to be sent according to the routing message. Then, in step 506, the source routing bus component sends the routing message to the second target component, so that the second target component performs action processing according to the routing message.

In the above steps, when the source routing bus component receives the call request sent by the message initiating component, it performs message encapsulation on the call request to obtain a routing message, the routing message including a message type field. The message type field refers to a field for indicating a message type. The message type includes, but is not limited to, an intra-app message, an out-of-app message, and so on. For example, an intra-app message may be denoted by 00, and an out-of-app message may be denoted by 11.

After the source routing bus component has encapsulated the call request, it can obtain the message type field of the routing message, and determine whether the message type of the routing message is an out-of-app message or an intra-app message according to the message type field included in the routing message. For example, in the case of the Android operating system, the message type field is identified through the ApkCommunicationManger class. When the message type field is identified as an intra-app message:

The source routing bus component scans the collected component service information through an automatic registration component RegisterLibrary, so as to query a second target component to which the routing message corresponds, or query a target component service to which the routing message corresponds; then, after the second target component is obtained by querying, the second target component can receive a routing message in the registered information management service, and parse the routing message.

The second target component obtains a message action type field contained in the routing message by parsing, and then determines an action type corresponding to the action type field according to the action type field. The action type includes but is not limited to calling a page, calling a service and a custom action. The custom action refers to a reserved blank action that can be set according to user needs.

When it is determined that the action type indicated by the action type field is calling a page, the routing message is encapsulated by, for example, a page calling service that comes with the Android system. At the same time, an original reference to the called page is retained in the routing message to facilitate the return of a response message when callback is made.

When it is determined that the action type indicated by the action type field is calling a service, corresponding component service information is encapsulated in the API class to execute callback according to the component service information stored in a service table collected by the automatic registration component by scanning. Specific service methods can all be encapsulated in the API class. After the execution of a service method produces a result, the current callback will be triggered. The source of callback may be another component in the same application, or a target message dispatch service component DispatchService that is remotely bound by other applications.

When it is identified that the message type field is an out-of-app message:

A target message dispatch service component DispatchService binding operation in the remote service is performed in the ApkCommunicationManger class, and meanwhile registration of a callback interface in the target message dispatch service component DispatchService is requested. After the binding operation and registration of a callback interface have been completed, the routing message is sent to the established external binding routing.

The ApkCommunicationManager class performs conversion and processing on the routing message by calling a message processor (DataWrapper), and transmits the routing message that has experienced the conversion and processing in a Binder transmission mode.

After the conversion and processing, after the target message dispatch service component DispatchService receives the routing message, it parses the routing message to obtain a message mode (BMessage) that can be identified by the target routing bus component, and injects new message callback (IMessageListener interface) during the parsing process. This message callback is used to realize processing of intra-app messages within the target application.

The target routing bus component receives the parsed routing message sent by the target message dispatch service component, and executes a communication flow between components within the target application according to the communication flow of intra-app messages, so as to realize corresponding action processing of the first target component on the routing message.

After the target application completes the above processings, the target message dispatch service component DispatchService is triggered to encapsulate a response message for the routing message and a callback method. This callback method will trigger the callback interface registered when the target message dispatch service component DispatchService is bound. The source routing bus component of the source application will transmit the response message to the message initiating component in the source application in an intra-app message processing mode.

In the embodiment of the present disclosure, regardless of intra-app communication or out-of-app communication, the callback result can be obtained by message callback.

When the call processing is finished, callback is executed. For example, in the case of out-of-app communication, when the target message dispatch service component DispatchService is bound in the source routing bus component by binding a remote service, the registered interface callback method is triggered, and the interface callback method will receive a response message of message processing. In the interface callback method, after receiving the response message, it will trigger the response message to return to the source routing bus component through the callback interface.

In the case of intra-app communication, the message callback held in the BMessage is directly executed in the source routing bus component, so that a returned response message can be received.

The method for communication of a componentized application proposed by the embodiment of the present disclosure can identify a message type by the source routing bus component, and determine a routing path according to the message type, so as to realize free switching between communication between different applications and communication between components within the same application, thereby effectively improving the transmission efficiency of routing messages.

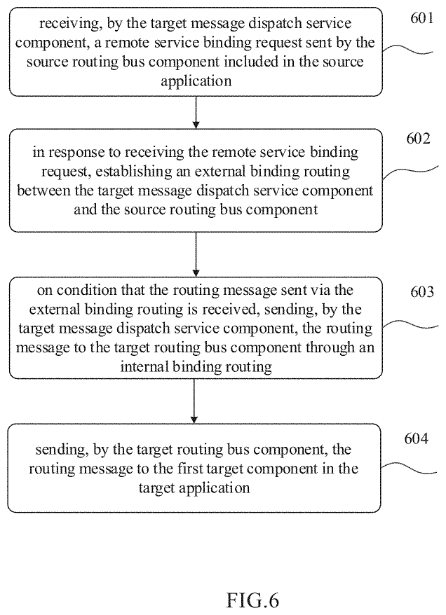

On the basis of the above embodiment, as shown in FIG. 6, FIG. 6 illustrates a flow chart of yet another method for communication of a componentized application provided by an embodiment of the present disclosure. The method may be executed by an application communication apparatus, which may be a component included in a target application based on a certain operating system (for example, Android operating system). The component includes, but is not limited to, an independently installed application or a composite component that implements a certain function in an application, and the component includes but is not limited to an activity or a service. The componentized application is a target to application, and the target application at least includes a first target component, a target routing bus component, and a target message dispatch service component. The method comprises the following steps.

Step 601: Receiving, by the target message dispatch service component, a remote service binding request sent by the source routing bus component included in the source application.

Step 602: In response to receiving the remote service binding request, establishing an external binding routing between the target message dispatch service component and the source routing bus component. The external binding routing is a message transmission path between the source routing bus component and the target message dispatch service component in the target application, wherein the source routing bus component sends a routing message to the target message dispatch service component through the external binding routing.

Step 603: On condition that the routing message sent via the external binding routing is received, sending, by the target message dispatch service component, the routing message to the target routing bus component through an internal binding routing. The internal binding routing is a message transmission path between the target message dispatch service component and the target routing bus component.

Step 604: Sending, by the target routing bus component, the routing message to the first target component in the target application.

In the above steps, after the target application establishes an external binding routing with the source application, the target message dispatch service component of the target application receives a binding request (i.e., remote service binding request) sent by the source routing bus component, and in response to the binding request, an external binding routing is established between the target message dispatch service component and the source routing bus component.

For example, in the case of the Android operating system, by clicking on binding a remote service in the source application, the extension of the interface file of the target message dispatch service component in the target application can be modified as .aidl file to realize the onbind method of service, inherit Bander and implement the interface defined by aidl, so as to provide the interface of the target message dispatch service component to the method of calling an interface.

On the basis of the above embodiment, the method further comprises:

when the target application is started, establishing, by the target routing bus component, the internal binding routing, and requesting registration of a third callback interface from the target routing bus component to the target message dispatch service component. The third callback interface is used to transmit a message from the target message dispatch service component to the target routing bus component. For example, when the target application is started, an initialization method of the component management class in the target application is called to establish the internal binding routing between the target routing bus component and the target message dispatch service component, and request registration of a callback interface from the target routing bus component to the target message dispatch service component.

In the embodiment of the present disclosure, the target message dispatch service component is used as an external access interface of the target application by binding a remote service, which realizes the separation of internal and external communication functions of the application and improves the transmission efficiency of routing messages.

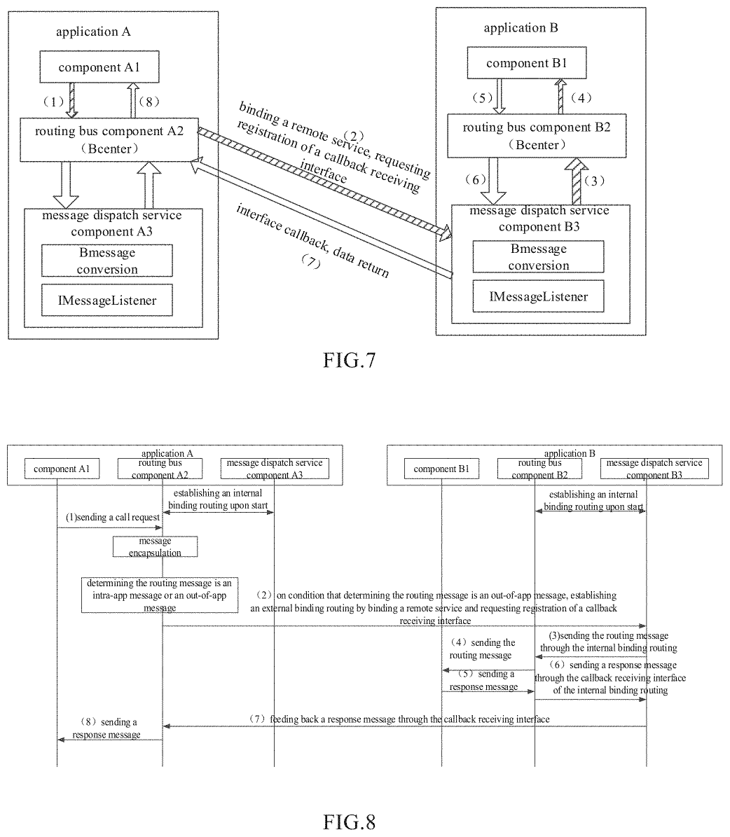

Hereinafter, FIGS. 7-10 are taken as examples. It is assumed that the source application based on the Android system is an application A, and the application A includes a message initiating component A1, a source routing bus component (Bcenter) A2, and a source message dispatch service component A3; the target application based on the Android system is an application B, and the application B includes a message processing component B1, a target routing bus component (Bcenter) B2, and a target message dispatch service component B3. The message initiating to component A1 includes, but is not limited to, a composite component that implements a certain function.

FIGS. 7 and 8 illustrate schematic views of communication paths between applications proposed by embodiments of the present disclosure.

(1) The message initiating component A1 sends a call request to the source routing bus component A2, for example, a request for calling the page provided by the message processing component B1.

(2) The source routing bus component A2 performs message encapsulation on the call request to obtain a routing message, the routing message including a message type field. The source routing bus component A2 acquires the message type field of the routing message, and determines whether the routing message belongs to an intra-app message or an out-of-app message according to the message type field.

(3) On condition that the source routing bus component A2 determines that the message type of the routing message is an out-of-app message, the source routing bus component A2 establishes an external binding routing by binding a remote service, and sends a request to the target message dispatch service component B3 of the target application B for registering a callback interface (IMessageListener interface). The external binding routing is a message transmission path between the source routing bus component A2 and the target message dispatch service component B3 in the target application B. The source routing bus component A2 sends the routing message to the target message dispatch service component B3 through the external binding routing.

(4) The target message dispatch service component B3 sends the routing message to the target routing bus component B2 through the internal binding routing therebetween; the target routing bus component B2 sends the routing message to the message processing component B1 in the target application.

(5) The message processing component B1 returns a response message for the routing message to the target routing bus component B2.

(6) The target routing bus component B2 encapsulates the response message into a message identifiable by the target message dispatch service component B3, and returns it to the target message dispatch service component B3 through the callback interface.

(7) The target message dispatch service component B3 transmits the response message back to the source routing bus component A2 through the callback interface (IMessageListener interface) registered between the source routing bus component A2 and the target message dispatch service component B3.

(8) The source routing bus component A2 feeds back the response message to the message initiating component A1.

After the above steps, a complete communication between the message initiating component A1 of the application A and the message processing component B1 of the application B is accomplished.

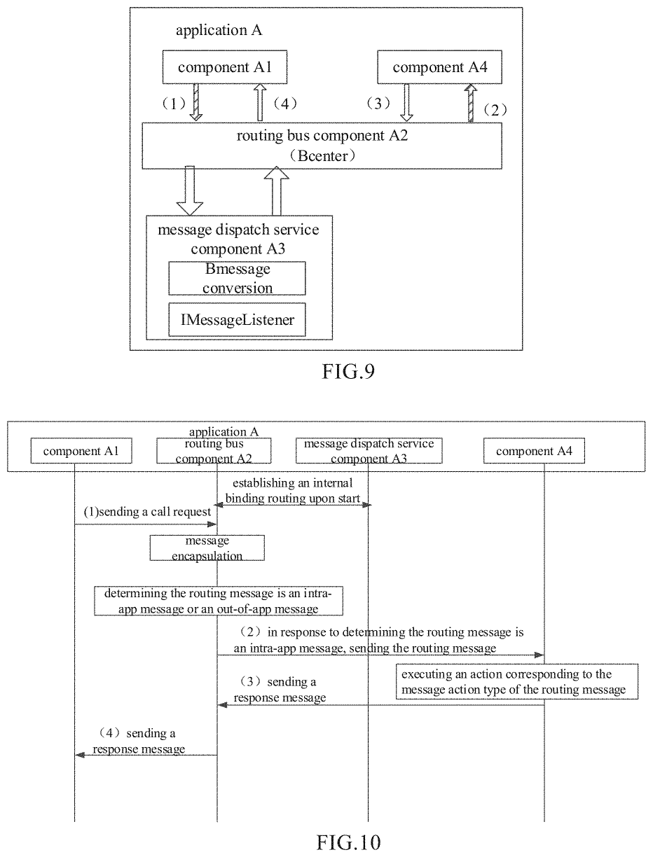

In some embodiments, the application A may further include a component A4. FIGS. 9 and 10 illustrate schematic views of communication paths within an application proposed by an embodiment of the present disclosure.

(1) The source routing bus component A2 receives a routing message sent by the component A1. When the source routing bus component A2 determines that the message type of the routing message is an intra-app message, the source routing bus component A2 can acquire component service information obtained by scanning according to the target object of the routing message.

(2) The source routing bus component A2 determines a target component A4 in the source application according to the routing message. As an example, the source routing bus component A2 acquires component service information obtained by scanning according to the target object of the routing message, and then determines a target component A4 in the source application according to the component service information.

The source routing bus component A2 sends the routing message to to the target component A4, so that the target component performs action processing according to the routing message.

(3) The target component A4 acquires a message action type field of the routing message, performs action processing corresponding to the message action type on the routing message according to the message action type, and returns a corresponding action processing result as a response message to the routing bus component A2.

When the message action type is a page calling action, a page calling service is called to encapsulate the routing message to perform page calling.

When the message action type is a service calling action, according to the service information stored in the scanning information table of the registration component, the routing message is routed to the interface class callback to perform service calling.

When the message action type is a custom action, the routing message is sent to a corresponding component according to the custom action parameters. For example, if the custom action is to obtain data, corresponding data is obtained as a response message by a corresponding component according to query parameters. For example, if the custom action is to transmit data, identification parameters of a corresponding component are obtained, and data to be transmitted is sent to the corresponding component in the same application through the internal binding routing according to the identification parameters.

(4) The source routing bus component A2 returns the response message to the component A1.

In the embodiment of the present disclosure, forwarding of routing messages within an application is realized by the source routing bus component, which effectively improves the communication efficiency of each component within the application.

The flow charts and block diagrams in the accompanying drawings illustrate the architectures, functions and operations of possible implementations of the system, method and computer program product according to various embodiments of the present disclosure. Each block in the flow chart or block diagram may represent a module, a program segment or a part of a code, and the module, the program segment, or a part of the code contains one or more executable instructions for realizing specified logical functions. It is also to be noted that, in some alternative implementations, the functions marked in the blocks may also occur in a different order from the order marked in the drawings. For example, two consecutive blocks can actually be executed substantially in parallel, or they can sometimes be executed in a reverse order, depending on the functions involved. It is also to be noted that each block in the block diagram and/or flow chart, and a combination of blocks in the block diagram and/or flow chart, can be implemented by a dedicated hardware-based system that performs specified functions or operations, or can be implemented by a combination of dedicated hardware and computer instructions.

Referring to FIG. 11, FIG. 11 illustrates a schematic structural view of an apparatus for communication of a componentized application provided by an embodiment of the present disclosure. The apparatus is a component included in an application based on a certain operating system. The component includes but is not limited to an independently installed application or a composite component that implements a certain function in an application. The component includes but is not limited to an activity or a service. The apparatus comprises: a source routing bus component, wherein,

a source routing bus component 901 is configured to acquire a routing message to be sent; in response to a message type of the routing message being an out-of-app message to be sent to a first target component included in a target application, establish an external binding routing by binding a remote service, the external binding routing being a message transmission path between the source routing bus component and a target message to dispatch service component in the target application to which the routing message is to be sent;

the source routing bus component 901 is further configured to send the routing message to the target message dispatch service component through the external binding routing, so that the first target component in the target application obtains the routing message.

Optionally, the source routing bus component 901 is further configured to send a request to the target message dispatch service component of the target application for registering a first callback interface while the source routing bus component establishes an external binding routing by binding a remote service. The first callback interface is used to transmit a response message fed back by the first target component of the target application for the routing message to the source routing bus component.

Optionally, the source routing bus component is further configured to:

call a message processor to determine whether the routing message includes target type data;

in response to determining that the routing message includes the target type data, performing format conversion processing on the routing message to obtain a routing message in a target format suitable for cross-application transmission;

sending the routing message in the target format to the target message dispatch service component through the external binding routing;

in response to determining that the routing message does not include the target type data, directly sending the routing message to the target message dispatch service component through the external binding routing.

The apparatus further comprises a source message dispatch service component. The source routing bus component is further configured to establish an internal binding routing between the source routing bus component and the source message dispatch service component when the application is started, and the source routing bus component sends a to request to the source message dispatch service component for registering a second callback interface.

Optionally, the apparatus further includes a message initiating component. The source routing bus component is further configured to receive a call request sent by the message initiating component, and perform message encapsulation on the call request to obtain the routing message. The routing message includes a message type field indicating whether the routing message is an intra-app message or an out-of-app message.

The source routing bus component is further configured to obtain the message type field of the routing message; determine the message type of the routing message belongs to an intra-app message or an out-of-app message according to the message type field.

The source routing bus component is further configured to:

determine a second target component included in the componentized application to which the routing message is to be sent according to the routing message when it is determined that the message type of the routing message is an intra-app message;

send the routing message to the second target component, so that the second target component performs action processing according to the routing message.

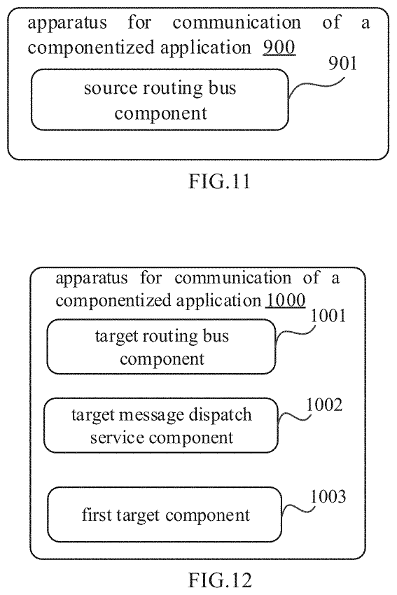

Referring to FIG. 12, FIG. 12 illustrates a schematic structural view of another apparatus 1000 for communication of a componentized application according to an embodiment of the present disclosure. The apparatus is a component included in an application based on a certain operating system. The component includes but is not limited to an independently installed application or a composite component that implements a certain function in an application. The component includes but is not limited to an activity or a service. The apparatus comprises: a target routing bus component 1001, a target message dispatch service component 1002, and a first target component 1003.

The target message dispatch service component 1001 is configured to receive a remote service binding request sent by a source routing bus component included in the source application; in response to receiving the remote service binding request, establish an external binding routing between the target message dispatch service component and the source routing bus component.

The target message dispatch service component 1001 is further configured to transmit the routing message to the target routing bus component through an internal binding routing between the target message dispatch service component and the target routing bus component when receiving the routing message sent via the external binding routing.

The target routing bus component 1002 is further configured to send the routing message to the first target component 1003 of the target application.

Optionally, the target routing bus component 1002 is further configured to establish an internal binding routing when the target application is started, and request registration of a callback interface from the target routing bus component to the target message dispatch service component.

It should be understood that the units or modules recited in the above apparatus correspond to the steps in the method described with reference to FIG. 3. Therefore, the operations and features described above for the method are also applicable to the above apparatus and the units included therein, and will not be repeated here. The above apparatus may be implemented in the browser of a computing device or other security projects in advance, and may also be loaded into the browser of a computing device or other security projects by downloading or the like. The respective units in the above apparatuses can cooperate with units in a computing device to implement the solutions in the embodiments of the present disclosure.

For the modules or units mentioned in the detailed description above, this division is not mandatory. In fact, according to the embodiments of the present disclosure, the features and functions of two or more modules or units described above may be embodied in one module or unit. On the contrary, the features and functions of a module or unit described above may be further divided into multiple modules or units to be embodied.

Some embodiments of the present disclosure further provide a system for communication of a componentized application. The system may comprise the apparatus for communication of a componentized application as shown in FIG. 11 and FIG. 12.

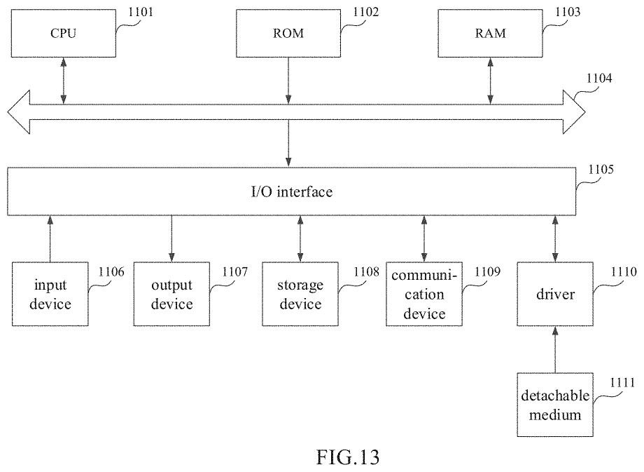

FIG. 13 illustrates a schematic structural view of a computer system that can be used to implement the embodiments of the present disclosure. The computer system may also be implemented as a computing device.

As shown in FIG. 13, the computer system comprises a central processing unit (CPU) 1101, which can perform various appropriate actions and processing according to computer instructions stored in a read-only memory (ROM) 1102 or computer instructions loaded from a storage device 1108 to a random access memory (RAM) 1103. Various computer instructions and data required for the operation of the computer system are also stored in the RAM 1103. The CPU 1101, the ROM 1102, and the RAM 1103 are connected to each other through a bus 1104. An input/output (I/O) interface 1105 is also connected to the bus 1104.

The following components are connected to the I/O interface 1105: an input device 1106 including a keyboard, a mouse, etc.; an output device 1107 including a cathode ray tube (CRT), a liquid crystal display (LCD) and the like, and a loudspeaker and the like; a storage device 1108 including a hard disk, etc.; and a communication device 1109 including a network interface card such as a LAN card, a modem, and the like. The communication device 1109 performs communication processing via a network such as the Internet. A driver 1110 is also connected to the I/O interface 1105 as needed. A detachable medium 1111, such as a magnetic disk, an optical disk, a magneto-optical disk, a semiconductor memory, to and the like, is installed on the driver 1110 as needed, so that computer instructions read from therefrom can be installed into the storage device 1108 as needed.

In particular, according to an embodiment of the present disclosure, the process described above with reference to the flow charts of FIGS. 3-5 can be implemented as a computer software program. For example, an embodiment of the present disclosure comprises a computer program product, which includes computer instructions carried on a machine-readable medium. The computer instructions are computer-executable instructions and include program codes for executing the methods shown in the flow charts. In such an embodiment, the computer instructions may be downloaded from the network by the communication device 1109 and installed, and/or installed from the detachable medium 1111. When the computer instructions are executed by the central processing unit (CPU) 1101, the above-mentioned functions defined in the system of the present disclosure are performed.

It is to be noted that the computer-readable medium shown in the present disclosure may be a computer-readable signal medium or a computer-readable storage medium, or any combination thereof. The computer-readable storage medium may be a transitory storage medium or a non-transitory storage medium. For example, it may be, but not limited to, an electrical, magnetic, optical, electromagnetic, infrared, or semiconductor system, apparatus or device, or any combination thereof. More specific examples of computer-readable storage media may include, but are not limited to: a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores computer instructions, to and the computer instructions may be used by or in combination with an instruction execution system, apparatus or device. In the present disclosure, the computer-readable signal medium may include a data signal propagated in a baseband or as a part of a carrier wave, and computer-readable program codes are carried therein. This propagated data signal may take various forms, including but not limited to an electromagnetic signal, an optical signal, or any suitable combination thereof. The computer-readable signal medium may also be any computer-readable medium other than the computer-readable storage medium. The computer-readable medium may send, propagate or transmit computer instructions for use by or in combination with an instruction execution system, apparatus or device. The program codes contained on the computer-readable medium can be transmitted by any suitable medium, including but not limited to: wireless, wire, optical cable, RF, etc., or any suitable combination thereof.

The flow charts and block diagrams in the accompanying drawings illustrate the architectures, functions and operations of possible implementations of the system, method and computer program product according to various embodiments of the present disclosure. Each block in the flow chart or block diagram may represent a module, a program segment or a part of a code, and the module, the program segment, or a part of the code contains one or more executable instructions for realizing specified logical functions. It is also to be noted that, in some alternative implementations, the functions marked in the blocks may also occur in a different order from the order marked in the drawings. For example, two consecutive blocks can actually be executed substantially in parallel, or they can sometimes be executed in a reverse order, depending on the functions involved. It is also to be noted that each block in the block diagram and/or flow chart, and a combination of blocks in the block diagram and/or flow chart, can be implemented by a dedicated hardware-based system that performs specified functions or operations, or can be implemented by a combination of dedicated hardware and computer instructions.

The units or modules involved in the embodiments of the present disclosure can be implemented in software or hardware. The described units or modules may also be provided in a processor, for example, it can be described as: a processor comprising a source routing bus component module, etc. The names of these units or modules do not constitute a limitation on the units or modules themselves in certain cases. For example, the source routing bus component module may also be described as “a module for receiving a routing message”.

As another aspect, the present disclosure further provides a computer-readable storage medium. The computer-readable storage medium may be included in the computing device described in the foregoing embodiments, and may also exist independently without being assembled into the computing device. The aforementioned computer-readable storage medium stores one or more computer instructions, which is used to execute the method for communication of a componentized application described in the present disclosure when the computer instructions are executed by one or more processors.

What have been described are only a part of the embodiments of the present disclosure and explanations of the applied technical principles. Those skilled in the art should understand that the inventive scope involved in the present disclosure is not limited to technical solutions formed by specific combinations of the above technical features, and should also encompass other technical solutions formed by any combinations of the above technical features or their equivalent features without departing from the inventive concept, for example, technical solutions formed by replacing the above features and technical features having similar functions as those disclosed in the present disclosure (but not limited to) with each other.

1. A method for communication of a componentized application, the componentized application at least comprising a source routing bus component, and the method comprising:
acquiring, by the source routing bus component, a routing message to be sent;
in response to a message type of the routing message being an out-of-app message to be sent to a first target component included in a target application, establishing, by the source routing bus component, an external binding routing by binding a remote service, the external binding routing being a message transmission path between the source routing bus component and a target message dispatch service component in the target application to which the routing message is to be sent; and
sending, by the source routing bus component, the routing message to the target message dispatch service component through the external binding routing, so that the first target component in the target application obtains the routing message.

2. The method according to claim 1, wherein said establishing, by the source routing bus component, an external binding routing by binding a remote service comprises:
while the source routing bus component establishes the external binding routing by binding a remote service, sending, by the source routing bus component to the target message dispatch service component of the target application, a request for registering a first callback interface, the first callback interface being configured to transmit a response message fed back by the first target component of the target application for the routing message to the source routing bus component.

3. The method according to claim 1, wherein said sending, by the source routing bus component, the routing message to the target message dispatch service component through the external binding routing comprises:
determining whether the routing message comprises target type data;
in response to determining that the routing message comprises the target type data, performing format conversion processing on the routing message to obtain a routing message in a target format suitable for cross-application transmission; and
sending the routing message in the target format to the target message to dispatch service component through the external binding routing.

4. The method according to claim 3, further comprising:
in response to determining that the routing message does not comprise the target type data, directly sending the routing message to the target message dispatch service component through the external binding routing.

5. The method according to claim 1, wherein the componentized application further comprises a source message dispatch service component, and the method further comprises:
in response to the componentized application being started, establishing an internal binding routing between the source routing bus component and the source message dispatch service component, and sending, by the source routing bus component to the source message dispatch service component, a request for registering a second callback interface, the second callback interface being configured to transmit a message from the source message dispatch service component to the source routing bus component, the internal binding routing being a message transmission path between the source routing bus component and the source message dispatch service component.

6. The method according to claim 1, wherein the componentized application further comprises a message initiating component, and said acquiring, by the source routing bus component, a routing message to be sent further comprises:
receiving, by the source routing bus component, a call request sent by the message initiating component; and
performing, by the source routing bus component, message encapsulation on the call request to obtain the routing message, the routing message comprising a message type field indicating whether the routing message is an intra-app message or an out-of-app message,
wherein the intra-app message indicates that the routing message is to be sent to other components included in the componentized application.

7. The method according to claim 6, further comprising:
in response to the source routing bus component acquiring a routing message to be sent, acquiring, by the source routing bus component, a message type field included in the routing message; and
determining, by the source routing bus component, whether the message type of the routing message is an out-of-app message or an intra-app message according to the message type field included in the routing message.

8. The method according to claim 1, further comprising:
in response to the message type of the routing message being an intra-app message to be sent to other components included in the componentized application, determining, by the source routing bus component, a second target component included in the componentized application to which the routing message is to be sent according to the routing message; and
sending, by the source routing bus component, the routing message to the second target component, so that the second target component performs action processing according to the routing message.

9. A method for communication of a componentized application, the componentized application comprising a first target component, a target routing bus component, and a target message dispatch service component, and the method comprising:
receiving, by the target message dispatch service component, a remote service binding request sent by a source routing bus component included in a source application;
in response to receiving the remote service binding request, establishing an external binding routing between the target message dispatch service component and the source routing bus component, the external binding routing being a message transmission path between the source routing bus component and the target message dispatch service component in the componentized application, wherein the source routing bus component sends a routing message to the target message dispatch service component through the external binding routing;
in response to the routing message sent through the external binding routing being received, sending, by the target message dispatch service component, the routing message to the target routing bus component through an internal binding routing, the internal binding routing being a message transmission path between the target message dispatch service component and the target routing bus component; and
sending, by the target routing bus component, the routing message to the first target component in the componentized application.

10. The method according to claim 9, further comprising:
in response to a target application being started, establishing, by the target routing bus component, the internal binding routing, and requesting registration of a third callback interface from the target routing bus component to the target message dispatch service component, the third callback interface being configured to transmit a message from the target message dispatch service component to the target routing bus component.

11. A computing device, comprising a processor and a memory having computer instructions stored thereon that perform the method according to claim 1 when the computer instructions are executed by the processor.

12. A computing device, comprising a processor and a memory having computer instructions stored thereon that perform the method to according to claim 9 when the computer instructions are executed by the processor.

13. A non-transitory computer-readable storage medium having computer instructions stored thereon that perform the method according to claim 1 when the computer instructions are executed.

14. The non-transitory computer-readable storage medium according to claim 13, wherein said establishing, by the source routing bus component, an external binding routing by binding a remote service comprises:
while the source routing bus component establishes an external binding routing by binding a remote service, sending, by the source routing bus component to the target message dispatch service component of the target application, a request for registering a first callback interface, the first callback interface being configured to transmit a response message fed back by the first target component of the target application for the routing message to the source routing bus component.

15. The non-transitory computer-readable storage medium according to claim 13, wherein the componentized application further comprises a source message dispatch service component, and the following operations are further performed when the computer instructions are executed:
in response to the componentized application being started, establishing an internal binding routing between the source routing bus component and the source message dispatch service component, and sending, by the source routing bus component to the source message dispatch service component, a request for registering a second callback interface, the second callback interface being configured to transmit a message from the source message dispatch service component to the source routing bus component, the internal binding routing being a to message transmission path between the source routing bus component and the source message dispatch service component.

16. The non-transitory computer-readable storage medium according to claim 13, wherein the componentized application further comprises a message initiating component, and said acquiring, by the source routing bus component, a routing message to be sent further comprises:
receiving, by the source routing bus component, a call request sent by the message initiating component; and
performing, by the source routing bus component, message encapsulation on the call request to obtain the routing message, the routing message comprising a message type field indicating whether the routing message is an intra-app message or an out-of-app message,
wherein the intra-app message indicates that the routing message is to be sent to other components included in the componentized application.

17. The non-transitory computer-readable storage medium according to claim 16, wherein the following operations are further performed when the computer instructions are executed:
in response to the source routing bus component acquiring a routing message to be sent, acquiring, by the source routing bus component, a message type field included in the routing message; and
determining, by the source routing bus component, whether the message type of the routing message is an out-of-app message or an intra-app message according to the message type field included in the routing message.

18. The non-transitory computer-readable storage medium according to claim 13, wherein the following operations are further performed when the computer instructions are executed:
in response to the message type of the routing message being an intra-app message to be sent to other components included in the componentized application, determining, by the source routing bus component, a second target component included in the componentized application to which the routing message is to be sent according to the routing message; and
sending, by the source routing bus component, the routing message to the second target component, so that the second target component performs action processing according to the routing message.

19. A non-transitory computer-readable storage medium having computer instructions stored thereon that perform the method according to claim 9 when the computer instructions are executed.

20. The non-transitory computer-readable storage medium according to claim 19, wherein the following operations are further performed when the computer instructions are executed:
in response to a target application being started, establishing, by the target routing bus component, the internal binding routing, and requesting registration of a third callback interface from the target routing bus component to the target message dispatch service component, the third callback interface being configured to transmit a message from the target message dispatch service component to the target routing bus component.
